(19) United States
(12) Patent Application Publication
(10) Pub. No.: US 2024/0411841 A1
(43) Pub. Date: Dec. 12, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Ryo Tandai, Kanagawa (JP)

(73) Assignee: FUJIFILM Business Innovation Corp., Tokyo (JP)

(21) Appl. No.: 18/517,253

(22) Filed: Nov. 22, 2023

(30) Foreign Application Priority Data
Jun. 8, 2023 (JP) 2023-095009

(51) Int. Cl. G06F 21/10

(52) U.S. Cl. CPC G06F 21/1079; G06F 21/1078; G06F 2221/2137

(57) ABSTRACT

An information processing system includes one or more processors configured to: receive a request for issuance of an access token to be used when a service is used; provide an instruction for issuance of the access token and a refresh token to be used to, when a validity period of the access token has expired, refresh the access token; acquire the access token and the refresh token issued in response to the instruction; refresh the access token, using the refresh token, based on a predetermined refresh condition; and discard the refresh token, based on a predetermined condition on discarding.

### CROSS-REFERENCE TO RELATED APPLICATIONS

This application is based on and claims priority under 35 USC 119 from Japanese Patent Application No. 2023-095009 filed Jun. 8, 2023.

### BACKGROUND

### (i) Technical Field

The present disclosure relates to an information processing system, an information processing method, and a non-transitory computer readable medium.

### (ii) Related Art

In Japanese Patent No. 6354407, a disclosure relating to an authentication system is provided. In order to be capable of determining, based on a validity period, whether or not to permit use of a service using an existing authentication mechanism, the authentication system includes a storing unit that stores a validity period of a service provided for a client, a reception unit that receives an issuance request for an access token to be used for use of the service from the client, an issuance unit that issues the access token, based on the validity period, in response to reception of the issuance request, a determining unit that determines, in response to reception of the access token from the client, that the access token is valid in the case where the current date and time does not exceed the validity period of the service corresponding to the access token and that the access token is not valid in the case where the current date and time exceeds the validity period.

Furthermore, in Japanese Unexamined Patent Application Publication No. 2021-196908, a disclosure relating to a server apparatus that mediates provision of a service to a device is provided. In order to be capable of properly discarding authentication information for provision of the service after use of a device for which a service provision period is limited is finished, the server apparatus includes an authentication information acquisition unit that acquires authentication information for provision of the service, a device management unit that receives device information from the device and manages the device information, a user information management unit that manages user information about a user who uses the device, the authentication information, and the device information in association with one another, and a device determining unit that determines whether or not the device is a restricted device for which a service provision period of the service is limited. In the case where the device is a restricted device and a certain period of time has passed since start of the service provision period for the restricted device, the user information management unit invalidates and deletes the authentication information associated with the device information.

### SUMMARY

In a system that requires an access token to use a service, in the case where the service is often used for a long period of time, it is desirable that the access token be held for a long period of time, in terms of ensuring user-friendliness. Thus, the access token is refreshed using a refresh token. Meanwhile, holding an access token for a long period of time may increase the opportunity for a third party who does not have a permission to illegally use the access token, and the security risk of information leakage may increase.

Aspects of non-limiting embodiments of the present disclosure relate to reducing security risk by refreshing an access token by using a refresh token and reducing an opportunity for the token to be illegally used, compared to the case where an access token is managed based on a validity period.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: receive a request for issuance of an access token to be used when a service is used; provide an instruction for issuance of the access token and a refresh token to be used to, when a validity period of the access token has expired, refresh the access token; acquire the access token and the refresh token issued in response to the instruction; refresh the access token, using the refresh token, based on a predetermined refresh condition; and discard the refresh token, based on a predetermined condition on discarding.

### BRIEF DESCRIPTION OF THE DRAWINGS

Exemplary embodiments of the present disclosure will be described in detail based on the following figures, wherein:

FIG. 1 is a diagram illustrating a configuration of the entire information processing system to which an exemplary embodiment is applied;

FIG. 2 is a diagram illustrating a hardware configuration of an information processing apparatus;

FIG. 3 is a diagram illustrating a hardware configuration of a service providing server and an authenticating server;

FIG. 4 is a diagram illustrating a functional configuration of the information processing apparatus;

FIG. 5 is a diagram illustrating an example of a user authentication management DB;

FIG. 6 is a diagram illustrating an example of a service access management DB;

FIG. 7 is a diagram illustrating an example of a login status management DB;

FIG. 8 is a diagram illustrating an example of a token management DB;

FIG. 9 is a diagram illustrating an example of a service authentication management DB;

FIG. 10 is a diagram illustrating an example of a service association management DB;

FIG. 11 is a sequence diagram illustrating an example of a login process;

FIG. 12 is a sequence diagram illustrating an example of processing for acquiring a token;

FIG. 13 is a sequence diagram illustrating an example of a service execution process for a service requiring authentication;

FIG. 14 is a sequence diagram illustrating an example of processing for reacquiring an access token; and

FIG. 15 is a sequence diagram illustrating an example of processing for organizing a refresh token.

### DETAILED DESCRIPTION

Hereinafter, exemplary embodiments of the present disclosure will be described in detail with reference to accompanying drawings.

### <Configuration of Information Processing System>

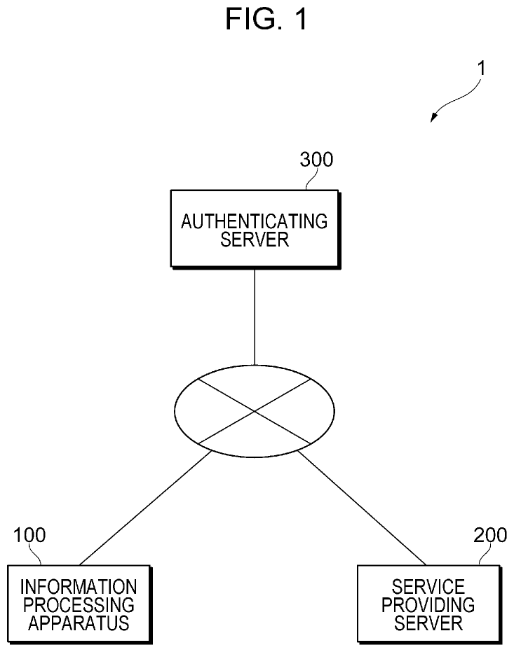

FIG. 1 is a diagram illustrating a configuration of an information processing system to which an exemplary embodiment is applied. An information processing system 1 includes an information processing apparatus 100, a service providing server 200, and an authenticating server 300. The information processing apparatus 100, the service providing server 200, and the authenticating server 300 are connected via a network.

The information processing apparatus 100 is an apparatus used by a user. The information processing apparatus 100 connects to the service providing server 200 so that a service is executed. For example, an image processing apparatus may be used as the information processing apparatus 100, and a simple mail transfer protocol (SMTP) server may be used as the service providing server 200. According to this exemplary embodiment, an image scanned by the image processing apparatus is attached to an electronic mail, and the electronic mail including the scanned image attached thereto is transmitted by the SMTP server to a destination. Furthermore, the information processing apparatus 100 connects to the authenticating server 300 and acquires an access token required to use a service of the service providing server 200. A system that issues an access token is, for example, an Open Authorization (OAuth) system.

The service providing server 200 is a server that provides a service in response to a request from a user. For example, in the case where an image processing apparatus serves as the information processing apparatus 100 and an SMTP server serves as the service providing server 200 as described above, the SMTP server receives an electronic mail from the image processing apparatus and transmits the electronic mail to a destination. In order to provide a service, the service providing server 200 requires an access token issued by the authenticating server 300.

The authenticating server 300 is a server that issues an access token. In an authentication flow, the authenticating server 300 issues an access token in response to a request from the information processing apparatus 100, and transmits the issued access token to the information processing apparatus 100. The authentication flow is a procedure for acquiring an access token. The authenticating server 300 issues a refresh token as well as the access token, and transmits the issued refresh token along with the access token to the information processing apparatus 100. Hereinafter, in the case where there is no need to distinguish between an access token and a refresh token, they will be simply referred to as tokens. From the viewpoint of security, a validity period is set for an access token. A refresh token is a token used to reissue an access token when the validity period of the access token has expired. A validity period is set for a refresh token. The validity period of a refresh token is set longer than the validity period of an access token.

Furthermore, the authenticating server 300 reissues an access token in response to a request using a refresh token from a user. Issuance of an access token based on a request using a refresh token does not require an authentication flow. In the case where an access token is reissued, a refresh token is also reissued. When a token is reissued, the valid period of the token is extended according to the validity period set for the token. To issue a token, the authenticating server 300 authenticates a user. When authentication is successful, the authenticating server 300 issues a token.

### <Hardware Configuration of Information Processing Apparatus>

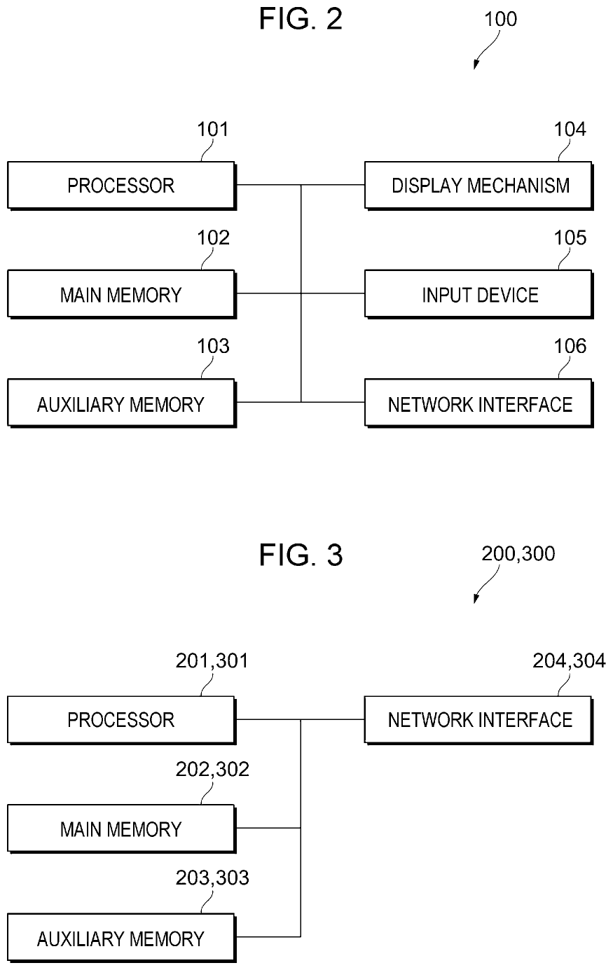

FIG. 2 is a diagram illustrating an example of the hardware configuration of the information processing apparatus 100. The information processing apparatus 100 illustrated in FIG. 2 includes one or more processors 101 as one or more operation units, a main memory 102 and an auxiliary memory 103 as memory units, a display mechanism 104 for allowing visual recognition of display information, an input device 105 to receive an operation from a user, and a network interface 106 used for information communication. The one or more processors 101 execute various functions of the information processing apparatus 100 by reading a program stored in the auxiliary memory 103 into the main memory 102 and executing the program. As each of the one or more processors 101, for example, a central processing unit (CPU), a microprocessing unit (MPU), a graphics processing unit (GPU), a digital signal processor (DSP), or the like is used. As the main memory 102, for example, a random access memory (RAM) is used. As the auxiliary memory 103, for example, a magnetic disk device or a solid state drive (SSD) is used. As the display mechanism 104, for example, a display is used. As the input device 105, for example, a keyboard, a mouse, or a touch panel is used. The configuration of the information processing apparatus 100 illustrated in FIG. 2 is merely an example, and the configuration of the information processing apparatus 100 used in this exemplary embodiment is not limited to the configuration example illustrated in FIG. 2. For example, a nonvolatile memory such as a flash memory or a read only memory (ROM) may be provided as a memory.

### <Hardware Configurations of Service Providing Server and Authenticating Server>

FIG. 3 is a diagram illustrating an example of the hardware configurations of the service providing server 200 and the authenticating server 300. The service providing server 200 and the authenticating server 300 illustrated in FIG. 3 include one or more processors 201 and 301 as one or more operation units, main memories 202 and 302 and auxiliary memories 203 and 303 as memory units, and network interfaces 204 and 304 used for information communication. The processors 201 and 301 execute various functions of the service providing server 200 and the authenticating server 300 by reading programs stored in the auxiliary memories 203 and 303 into the main memories 202 and 302 and executing the programs. As each of the one or more processors 201 and 301, for example, a CPU, an MPU, a GPU, a DSP, or the like is used. As each of the main memories 202 and 302, for example, a RAM is used. As each of the auxiliary memories 203 and 303, for example, a magnetic disk device or an SSD is used. The configurations of the servers illustrated in FIG. 3 are merely examples, and the configurations of the servers used in this exemplary embodiment are not limited to the configuration example illustrated in FIG. 3. For example, nonvolatile memories such as flash memories or ROMs may be provided as memories.

### <Functional Configuration of Information Processing Apparatus>

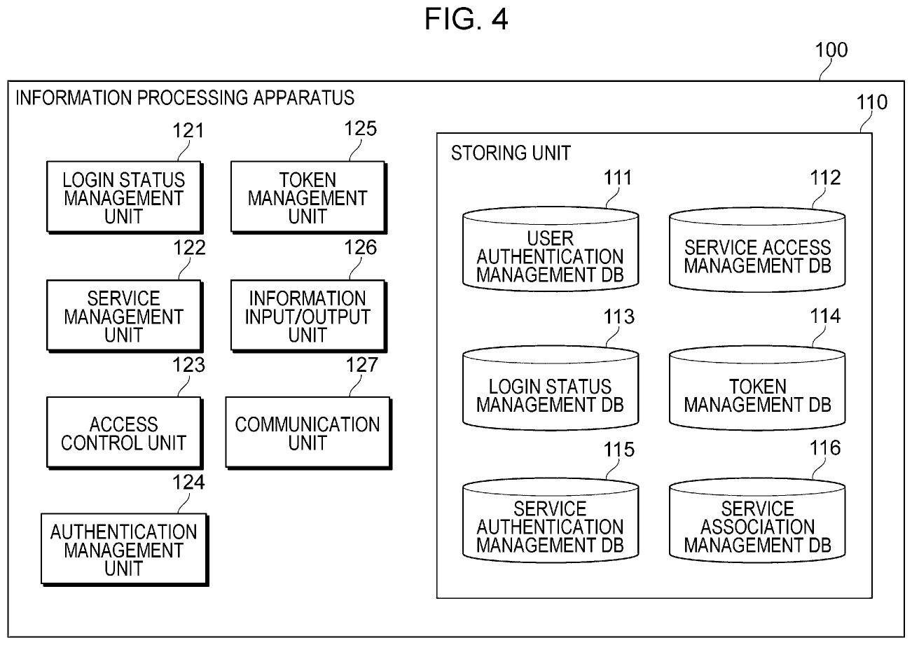

FIG. 4 is a diagram illustrating an example of the functional configuration of the information processing apparatus 100. The information processing apparatus 100 includes a storing unit 110, a login status management unit 121, a service management unit 122, an access control unit 123, an authentication management unit 124, a token management unit 125, an information input/output unit 126, and a communication unit 127. The functions of the information processing apparatus 100 are implemented when the processor 101 reads a program stored in the auxiliary memory 103 into the main memory 102 and executes the program. The information processing apparatus 100 displays various screens via the display mechanism 104 and receives input from a user via the input device 105. Furthermore, various databases are held in the auxiliary memory 103.

The storing unit 110 includes various databases (hereinafter, referred to as “DBs”). The storing unit 110 includes a user authentication management DB 111, a service access management DB 112, a login status management DB 113, a token management DB 114, a service authentication management DB 115, and a service association management DB 116.

FIG. 5 is a diagram illustrating an example of the user authentication management DB 111. The user authentication management DB 111 is a database that manages authentication information about users. In FIG. 5, a table in which information managed in the user authentication management DB 111 is stored is illustrated. For example, in the table illustrated in FIG. 5, a user ID field 701 and a password field 702 are provided, and user IDs and passwords are stored. A user ID is information for identifying a user. A password is information for authenticating a user. In this table, for example, information indicating that a password for a user with a user ID “aaa” (hereinafter, referred to as a “user aaa”) is “pass01” is recorded.

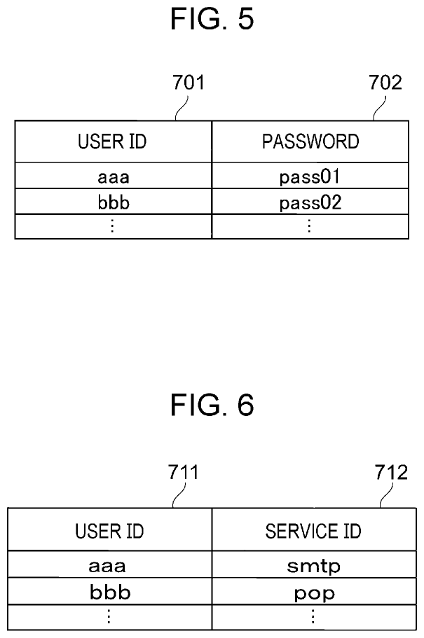

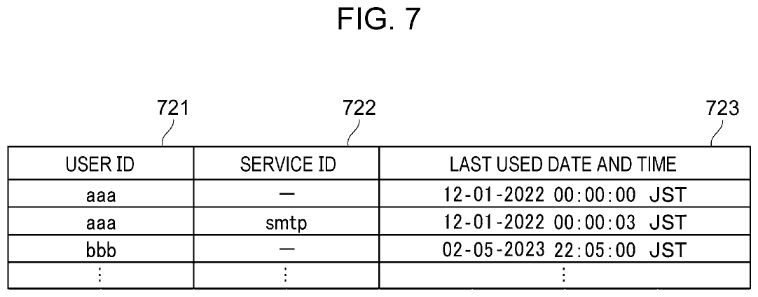

FIG. 6 is a diagram illustrating an example of the service access management DB 112. The service access management DB 112 is a database that manages services that users are able to use. In FIG. 6, a table in which information managed in the service access management DB 112 is stored is illustrated. For example, in the table illustrated in FIG. 6, a user ID field 711 and a service ID field 712 are provided, and user IDs and service IDs are stored. A service ID is information for identifying a service that a user is able to use. In this table, for example, information indicating that the user aaa is able to use a service with a service ID “smtp” (hereinafter, referred to as an “SMTP service”) is recorded.

FIG. 7 is a diagram illustrating an example of the login status management DB 113. The login status management DB 113 is a database that manages last dates and times at which users used services. In FIG. 7, a table in which information managed in the login status management DB 113 is stored is illustrated. For example, in the table illustrated in FIG. 7, a user ID field 721, a service ID field 722, and a last used date and time field 723 are provided, and user IDs, service IDs, and information about last used dates and times are stored. The last used date and time represents the last date and time at which a user used a service. In this table, for example, information indicating that the user aaa used the SMTP service at 00:00:03 on Dec. 1, 2022 is recorded.

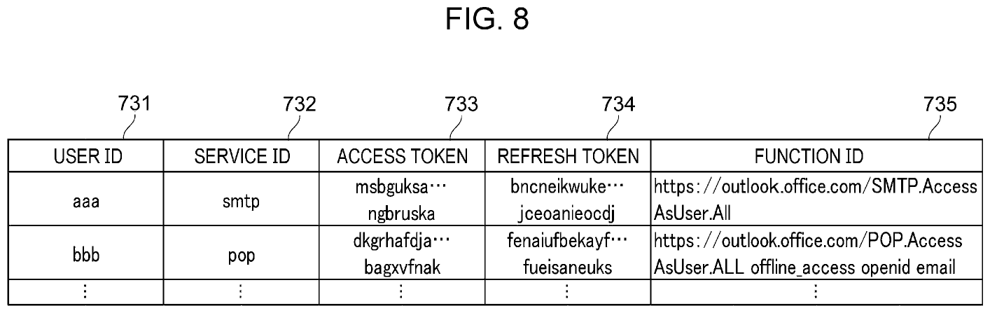

FIG. 8 is a diagram illustrating an example of the token management DB 114. The token management DB 114 is a database that manages access tokens and refresh tokens. In FIG. 8, a table in which information managed in the token management DB 114 is stored is illustrated. For example, in the table illustrated in FIG. 8, a user ID field 731, a service ID field 732, an access token field 733, a refresh token field 734, and a function ID field 735 are provided, and user IDs, service IDs, access tokens, refresh tokens, and function IDs are stored. A function ID is identification information indicating a service the use of which is permitted based on an access token.

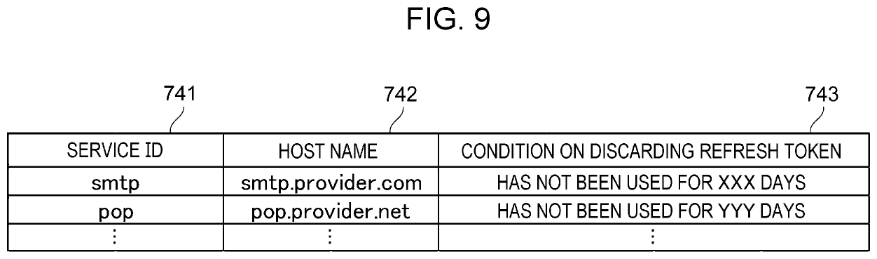

FIG. 9 is a diagram illustrating an example of the service authentication management DB 115. The service authentication management DB 115 is a database that manages conditions on discarding. In FIG. 9, a table in which information managed in the service authentication management DB 115 is stored is illustrated. For example, in the table illustrated in FIG. 9, a service ID field 741, a host name field 742, and a condition field 743 for conditions on discarding a refresh token are provided, and service IDs, host names, and conditions on discarding are stored. A host name is information for identifying the authenticating server 300 that issues a token in response to a request for issuance of a token from the information processing apparatus 100. A condition on discarding is a condition for discarding a token other than the reason of expiration of the validity period. A condition on discarding may be set by, for example, an administrator of the system. For example, a condition that a refresh token is discarded when a certain period of time has passed without a service being used by a user may be set (for example, the certain period of time will be referred to as a “discard period”). A discard period is set shorter than a validity period of a refresh token. Furthermore, a discard period may be set according to the type of a service to be used. In this table, for example, information indicating that a refresh token is discarded in the case where the SMTP service has not been used for XXX days is recorded. Thus, even when the validity period of a refresh token has not expired, if the condition on discarding is satisfied, the refresh token is discarded. The condition on discarding described above is merely an example, and a condition on discarding used in an exemplary embodiment is not limited to the condition described above.

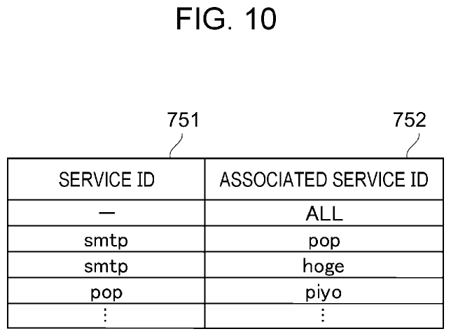

FIG. 10 is a diagram illustrating an example of the service association management DB 116. The service association management DB 116 is a database that manages a first service and a second service associated with the first service, in association with each other. In FIG. 10, a table in which information managed in the service association management DB 116 is stored is illustrated. For example, in the table illustrated in FIG. 10, a service ID field 751 and an associated service ID field 752 are provided, and service IDs and associated service IDs are stored. An associated service is a second service that is associated with a first service. For example, in the case where a user uses an electronic mail transmission service as a first service, it is considered that the user also uses an electronic mail reception service as a second service. Thus, it is considered that the electronic mail transmission service and the electronic mail reception service are associated with each other. In the table illustrated in FIG. 10, information indicating that the SMTP service and a service with a service ID “pop” (hereinafter, referred to as a “POP service”) are associated with each other is recorded.

The login status management unit 121 manages the login status of users. Specifically, the login status management unit 121 updates the last used date and time in the login status management DB 113 at the time when a user logs into a service. Furthermore, for processing for organizing a refresh token, the login status management unit 121 reads the login status management DB 113 and transmits information stored in the table in the login status management DB 113 to the access control unit 123.

The service management unit 122 manages services that users are able to use. Specifically, when a user has completed processing for logging into the information processing apparatus 100, the service management unit 122 reads the service access management DB 112 and displays services that the user is able to use. When a service is selected by the user, the service management unit 122 checks whether or not the selected service requires authentication. In the case where the selected service requires authentication, the service management unit 122 identifies a host name indicating the authenticating server 300 that issues a token required for authentication. Furthermore, for processing for organizing a refresh token, the service management unit 122 reads the service authentication management DB 115 and transmits information stored in the table in the service authentication management DB 115 to the access control unit 123.

The access control unit 123 performs access control for allowing a user to use a service. Specifically, the access control unit 123 has a role to control operation of the information processing apparatus 100 and transmits instructions to corresponding management units at the time of login processing by a user, processing for requesting issuance of a token, processing for executing a service, processing for reissuing an access token, and processing for organizing a token. The access control unit 123 also receives responses from the management units. For example, the access control unit 123 receives a request for issuance of an access token, provides an instruction to issue the access token, and acquires the issued access token. Furthermore, the access control unit 123 provides an instruction to refresh the access token by using a refresh token, based on a predetermined refresh condition, and provides an instruction to discard the refresh token, based on a predetermined condition on discarding. The details will be described later with reference to sequence diagrams.

Receiving selection of a service that a user wishes to use from the user is an example of a predetermined refresh condition. The refresh condition is not limited to the condition mentioned above. For example, in the case where a service is provided every certain period of time, lapse of the certain period of time may be set as a predetermined refresh condition.

Furthermore, the access control unit 123 receives information stored in the tables in the login status management DB 113, the token management DB 114, and the service authentication management DB 115 from the login status management unit 121, the service management unit 122, and the token management unit 125, which will be described later, at the time when processing for organizing a refresh token is performed, and determines whether or not the refresh token satisfies a condition on discarding.

In the case where a request for login processing, a request for issuance of a token, or a request for processing for executing a service is provided from a user, the authentication management unit 124 reads the user authentication management DB 111 and verifies whether the read information and authentication information input by the user match.

The token management unit 125 manages an access token and a refresh token. Specifically, when an instruction for requesting issuance of a token is provided by the access control unit 123, the token management unit 125 requires the authenticating server 300 to issue a token. The token management unit 125 acquires the token from the authenticating server 300 and stores the acquired token into the token management DB 114. Furthermore, at the time when the user performs processing for executing a service, the token management unit 125 transmits the acquired access token to the access control unit 123. For processing for organizing a refresh token, the token management unit 125 reads the token management DB 114 and transmits information stored in the table in the token management DB 114 to the access control unit 123.

The information input/output unit 126 is a user interface that displays a service selection screen and other screens for a user who uses the information processing apparatus 100 and receives input of authentication information about the user and selection of a service that the user wishes to use from the user.

The communication unit 127 controls communication with other apparatuses. The communication unit 127 performs transmission and reception of information via the communication unit 127, for example, in the case where the token management unit 125 requires the authenticating server 300 to issue a token and transmits an access token to the service providing server 200.

### <Description of Overview of Operation of Information Processing System>

The overview of operation of the information processing system 1 will be described. In this exemplary embodiment, it is assumed that a user needs to be authenticated to receive provision of a service. The user is able to receive provision of a service by using an access token acquired when an authentication flow is executed.

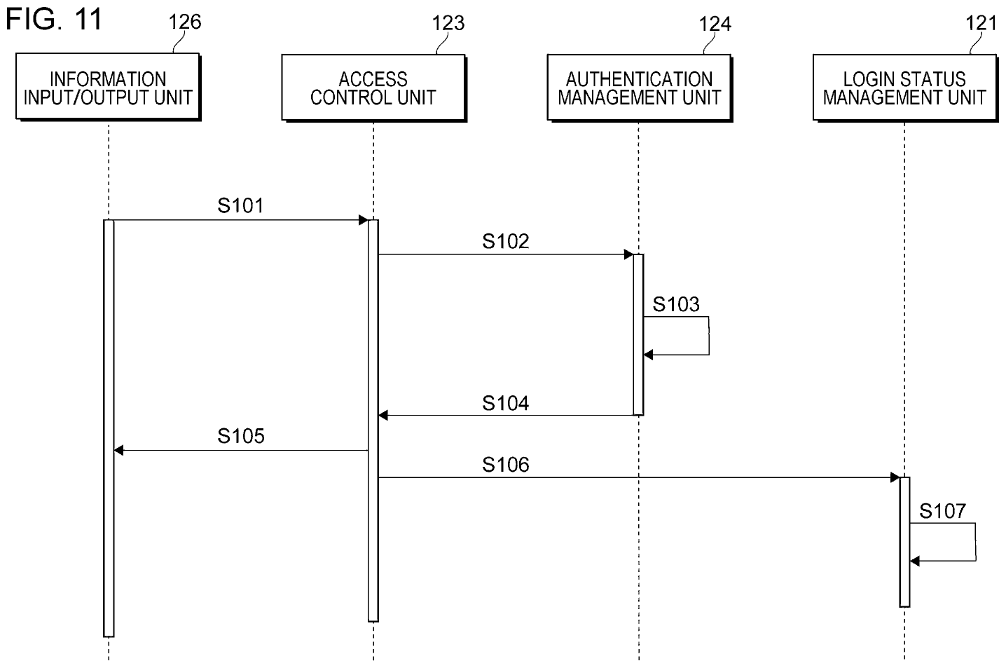

FIG. 11 is sequence diagram illustrating login processing by a user. The access control unit 123 receives, via the information input/output unit 126, a login request from the user (S101). The access control unit 123 instructs the authentication management unit 124 to verify authentication information (S102). The authentication management unit 124 reads the user authentication management DB 111 and verifies whether information input by the user and information managed in the user authentication management DB 111 match (S103). For example, the authentication management unit 124 may determine whether or not a user ID and a password input by the user and a user ID and a password managed in the user authentication management DB 111 match. In the case where authentication is successful, the authentication management unit 124 transmits an authentication result indicating that authentication is successful to the access control unit 123 (S104). In contrast, in the case where authentication is not successful, further operations are not performed. When receiving the authentication result indicating that authentication is successful from the authentication management unit 124, the access control unit 123 causes the information input/output unit 126 to display a screen for allowing the user to select a service (S105). Furthermore, the access control unit 123 instructs the login status management unit 121 to update the login status management DB 113 (S106). The login status management unit 121 updates the last used date and time managed in the login status management DB 113 (S107).

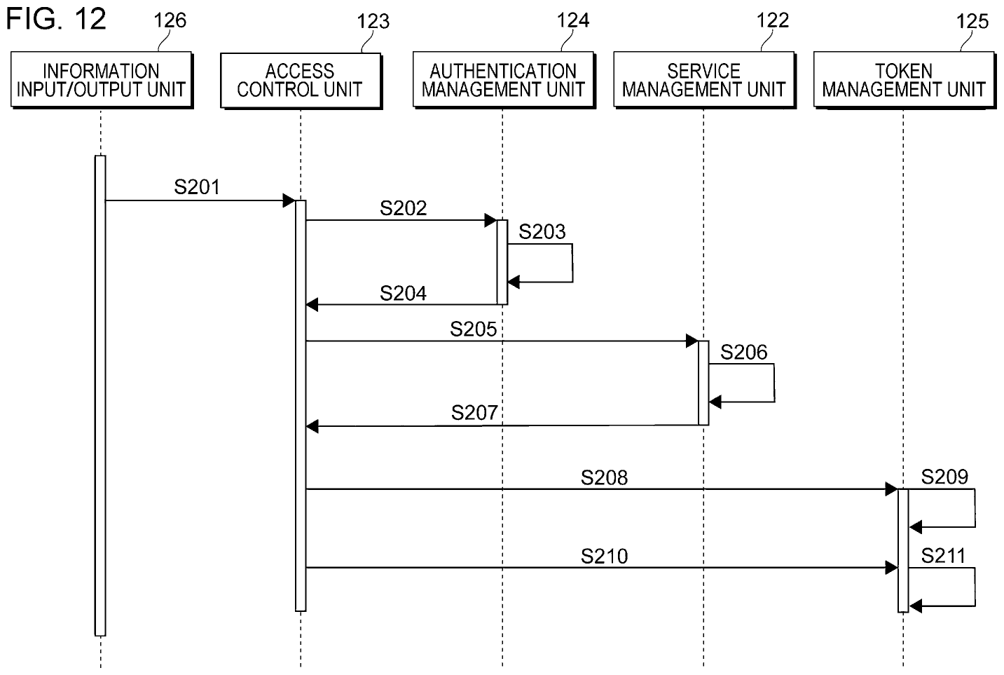

FIG. 12 is a sequence diagram illustrating processing for acquiring a token.

A user needs to execute an authentication flow to acquire an access token. More specifically, the access control unit 123 receives, via the information input/output unit 126, selection of a service that the user wishes to use from the user (S201). The access control unit 123 instructs the authentication management unit 124 to verify authentication information (S202). The authentication management unit 124 verifies authentication information as in S103 described above (S203). In the case where authentication is successful, the authentication management unit 124 transmits an authentication result indicating that authentication is successful to the access control unit 123 (S204). When receiving the authentication result indicating that authentication is successful from the authentication management unit 124, the access control unit 123 instructs the service management unit 122 to verify whether the service selected by the user requires authentication (S205). In the case where the service selected by the user requires authentication, the service management unit 122 identifies a host name indicating the authenticating server 300 that issues a token required for authentication (S206). The service management unit 122 transmits the identified host name to the access control unit 123 (S207).

The access control unit 123 instructs the token management unit 125 to require the authenticating server 300 corresponding to the host name identified in S206 to issue a token (S208). The token management unit 125 requires the authenticating server 300 to issue a token, and acquires the token from the authenticating server 300 (S209). The access control unit 123 instructs the token management unit 125 to store the acquired token into the token management DB 114 (S210). The token management unit 125 stores the acquired token into the token management DB 114 (S211).

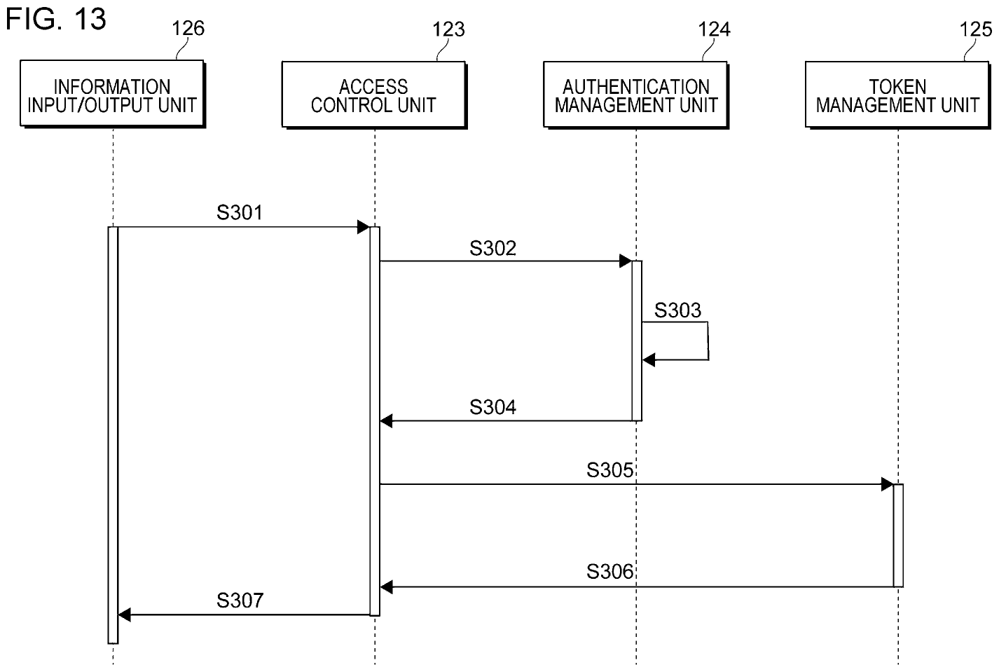

FIG. 13 is a sequence diagram illustrating processing for executing a service for a user.

The access control unit 123 receives, via the information input/output unit 126, selection of a service that a user wishes to use from the user (S301). The access control unit 123 instructs the authentication management unit 124 to check whether or not the user who wishes to use the service has been authenticated (S302). The authentication management unit 124 checks whether or not the user has been authenticated (S303). For example, in the case where the user has performed login processing, the authentication management unit 124 determines that the user has been authenticated. After confirming that the user has been authenticated, the authentication management unit 124 transmits an authentication result indicating that the user has been authenticated to the access control unit 123 (S304). The access control unit 123 instructs the token management unit 125 to transmit the access token acquired in S209 (S305). The access control unit 123 acquires the access token from the token management unit 125 (S306). The access control unit 123 transmits the access token to the service providing server 200 and provides the service to the user (S307).

As described above, from the viewpoint of security, a validity period is set for an access token, and the expired access token is discarded. To receive provision of the service again after the access token is discarded, the user needs to acquire the access token again.

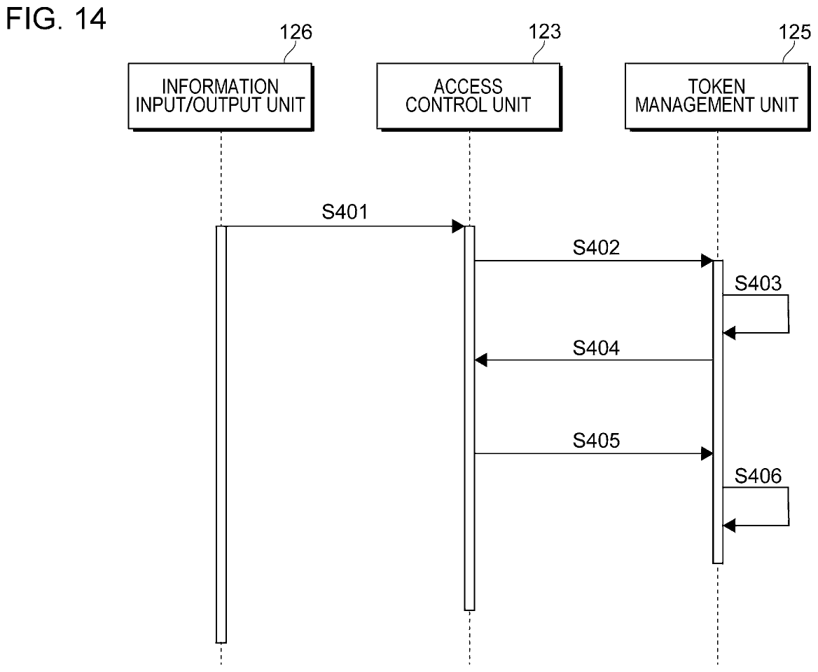

FIG. 14 is a sequence diagram illustrating processing for reacquiring an access token. Reacquisition of an access token is performed based on a predetermined refresh condition. In this reacquisition processing, a user does not need to execute an authentication flow to acquire an access token.

The access control unit 123 receives, via the information input/output unit 126, selection of a service that the user wishes to use from the user (S401). The access control unit 123 instructs the token management unit 125 to check whether or not an access token corresponding to the service selected by the user is valid (S402). The token management unit 125 checks whether or not the access token corresponding to the service selected by the user is valid (S403). For example, the access control unit 123 transmits a user ID and a service ID corresponding to the selected service to the token management unit 125. The token management unit 125 may read the token management DB 114, identify an access token corresponding to the user ID and the service ID received from the access control unit 123, and confirm the validity period of the access token. In the case where the validity period of the access token has expired, the token management unit 125 transmits a result indicating that the validity period of the access token has expired to the access control unit 123 (S404). When receiving the result indicating that the validity period of the access token has expired from the token management unit 125, the access control unit 123 instructs the token management unit 125 to request reissuance of the access token (S405). The token management unit 125 requires the authenticating server 300 to reissue a token by using a refresh token, and acquires the token (S406).

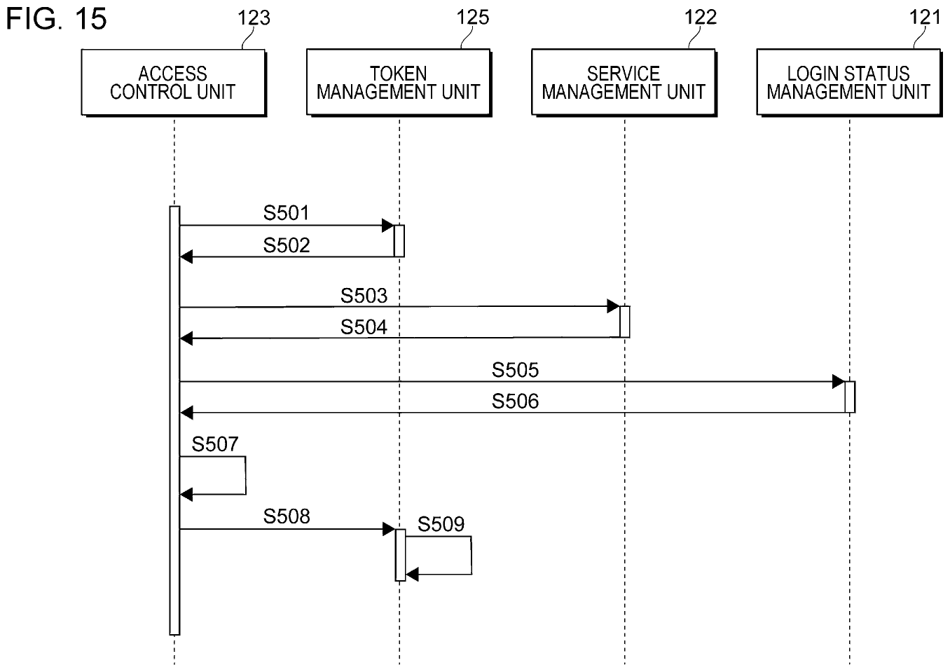

FIG. 15 is a sequence diagram illustrating processing for organizing a refresh token. In this exemplary embodiment, a discard period is used for a condition on discarding.

The access control unit 123 instructs the token management unit 125 to transmit information managed in the token management DB 114 (S501). The token management unit 125 reads the token management DB 114 and transmits the acquired information to the access control unit 123 (S502). For example, the token management unit 125 acquires information about a user ID, a service ID, and a refresh token managed in the token management DB 114 and transmits the acquired information. Furthermore, the access control unit 123 instructs the service management unit 122 to transmit information managed in the service authentication management DB 115 (S503). The service management unit 122 reads the service authentication management DB 115 and transmits the acquired information to the access control unit 123 (S504). For example, the service management unit 122 acquires information about a service ID, a host name, and a condition on discarding managed in the service authentication management DB 115 and transmits the acquired information. Furthermore, the access control unit 123 instructs the login status management unit 121 to transmit information managed in the login status management DB 113 (S505). The login status management unit 121 reads the login status management DB 113 and transmits the acquired information to the access control unit 123 (S506). For example, the login status management unit 121 acquires information about a user ID, a service ID, and last used date and time managed in the login status management DB 113 and transmits the acquired information.

The access control unit 123 determines, based on the information acquired in the processing from S501 to S506, a refresh token that satisfies the condition on discarding (S507). More specifically, the access control unit 123 confirms, based on each of the service IDs managed in the service authentication management DB 115, a validity period of a corresponding service. Furthermore, the access control unit 123 confirms, based on a user ID and a service ID managed in the login status management DB 113, the last date and time at which a corresponding service was used by a corresponding user, and identifies a period from the last date and time at which the service was used by the user to the date and time at which the processing for organizing a token was executed (hereinafter, the period from the last date and time at which the service was used by the user to the date and time at which the processing for organizing a token was executed will be referred to as a “non-used period”). Furthermore, regarding a refresh token managed by the token management unit 125, the access control unit 123 determines a condition on discarding by comparing the discard period with the non-used period. More specifically, for example, the access control unit 123 sets the discard period of a refresh token to seven days. In the case where the service was not used for ten days, which is from the last date and time at which the service was used by the user to the date and time at which the processing for organizing a token was executed, the non-used period is identified as ten days. Therefore, because the discard period is shorter than the non-used period, the access control unit 123 determines that the condition on discarding is satisfied. In the case where it is determined that the refresh token satisfies the condition on discarding, the access control unit 123 instructs the token management unit 125 to discard the refresh token (S508). The token management unit 125 discards the refresh token managed in the token management DB 114 (S509).

In the case where it is determined that the refresh token does not satisfy the condition on discarding, the access control unit 123 instructs the token management unit 125 to reissue a refresh token. As the destination from which the refresh token is acquired, the host name acquired from the service authentication management DB 115 may be used. Furthermore, in this processing, the user does not need to execute the authentication flow.

The processing for organizing the token may be set to be performed every predetermined period of time. Furthermore, the predetermined period of time may be set by, for example, a system administrator. By setting the discard period shorter than the validity period of the refresh token as the condition on discarding, in the case where the condition on discarding is satisfied, the refresh token may be discarded even within the validity period of the refresh token. Thus, since the period during which the token remains unused is shortened, the opportunity for a third party to illegally use the token decreases.

In the exemplary embodiment described above, the determination of the condition on discarding is performed based on the comparison between the discard period and the non-used period. In contrast, the determination of the condition on discarding may be performed based on the discard period, without using the last date and time at which a service was used. For example, in the case where the discard period has passed without the service being used during the period from the last date and time at which the organizing processing was executed to the date and time at which the current organizing processing is executed, even if the user used the service immediately before the determination of the condition on discarding was performed, it may be determined that the refresh token satisfies the condition on discarding and the refresh token may be discarded. More specifically, for example, the discard period of a refresh token is set to seven days, and a period for determining the condition on discarding is set to thirty days. In this case, even in the case where the user used the service within the period of seven days immediately before the determination of the condition on discarding was performed, if seven days had passed without the service being used during the past thirty days, the refresh token is discarded.

### <Modifications>

In the examples described above, the determination of the condition on discarding is performed based on the use status of a service by a user. However, in an exemplary embodiment, the determination of the condition on discarding may be performed based on the use statuses of a plurality of services by a user.

For example, a plurality of services that are associated with each other are set. In the case where one of the set plurality of services that are associated with each other is used, it may be determined that the condition on discarding is not satisfied for each of the plurality of services. In this case, in the processing for organizing a refresh token, in addition to operations in the processing from S501 to S506, the access control unit 123 acquires an associated service on the basis of an associated service ID managed in the service association management DB 116. Thus, by acquiring the use statuses of the plurality of services by the user, the access control unit 123 is capable of determining the condition on discarding on the basis of the use statuses of the plurality of services by the user. Examples of services include an electronic mail transmission service and an electronic mail reception service. Normally, it is considered that the user who uses the electronic mail transmission service also uses the electronic mail reception service. Thus, it is considered that the electronic mail transmission service and the electronic mail reception service are associated with each other. For example, in the case where the user does not use the electronic mail transmission service and a refresh token corresponding to the electronic mail transmission service satisfies the condition on discarding, even if the user continuously uses the electronic mail reception service, the refresh token corresponding to the electronic mail transmission service is discarded. Thus, even in the case where the user does not use the electronic mail transmission service, if the user uses the electronic mail reception service as a service associated with the electronic mail transmission service, it may be determined that the refresh token does not satisfy the condition on discarding. More specifically, the access control unit 123 acquires the last used date and time for the SMTP service via the login status management unit 121. Furthermore, the access control unit 123 also acquires the last used date and time for a service, for example, the POP service, set as an associated service that is associated with the SMTP service in the service association management DB 116, via the login status management unit 121. Thus, the determination of the condition on discarding is able to be performed based on the use statuses of the plurality of services. Therefore, even in the case where the discard period has passed without the SMTP service being used, if the POP service is used within the discard period, it is determined that a refresh token corresponding to the SMTP service does not satisfy the condition on discarding. Thus, the refresh token is not discarded.

Furthermore, in the case where there are a plurality of services that are able to be used using the same access token, if the use status of one of the plurality of services does not satisfy the condition on discarding a refresh token, it may be determined that none of the services using the same access token satisfies the condition on discarding. For example, in the case where an electronic mail transmission service, an electronic mail reception service, and a printing service are able to be used using the same access token, if the electronic mail transmission service or the electronic mail reception service is not used but the printing service is used during the discard period, it is determined that a refresh token corresponding to the electronic mail transmission service or the electronic mail reception service does not satisfy the condition on discarding. For example, in the operation of S506, the access control unit 123 acquires the last used dates and times for a plurality of services that are able to be used using the same access token from the login status management DB 113. In the operation of S507, the access control unit 123 may determine whether or not there is at least one of the plurality of services that does not satisfy the condition on discarding.

Furthermore, the determination of the condition on discarding may be performed based on the use statuses of services of a plurality of information processing apparatuses 100 that are in a specific relationship. The plurality of information processing apparatuses 100 that are in the specific relationship represent a plurality of information processing apparatuses 100 that are set to share, through data exchange, information about the use status of a service by a user. This modification is applicable to information processing apparatuses 100 connected to a local area network (LAN), information processing apparatuses 100 installed in a sales office, an office, or the like (hereinafter, referred to a “site”), and the like. Sharing of information about the use status of a service by a user may be implemented by, for example, exchanging information about the individual information processing apparatuses 100 or centralized management by a server on a network to which the information processing apparatuses 100 are connected.

For example, a case where a plurality of information processing apparatuses 100 are installed in a site and a user uses the information processing apparatuses 100 will be considered. To distinguish between the plurality of information processing apparatuses 100, a first information processing apparatus 100 and a second information processing apparatus 100 that are installed in the site will be referred to as an information processing apparatus 100A and an information processing apparatus 100B, respectively. Positions at which the information processing apparatuses 100 are installed are not limited as long as the positions are in the site where the information processing apparatuses 100 are able to be installed. For example, the information processing apparatus 100A and the information processing apparatus 100B may be installed at different positions on the same floor or may be installed on different floors.

A case where a user is able to use both the information processing apparatus 100A and the information processing apparatus 100B to use a service and the service is often used on the information processing apparatus 100A but is rarely used on the information processing apparatus 100B, will be considered. In the case where the determination of the condition on discarding a refresh token is performed for each apparatus, when the condition on discarding a refresh token for the information processing apparatus 100B is satisfied, the refresh token managed in the information processing apparatus 100B is discarded even if the information processing apparatus 100A uses the same service. In this case, to use the service using the information processing apparatus 100B, the user needs to execute the authentication flow again to acquire an access token, which requires more time and effort. Thus, in the case where the user uses the service using the information processing apparatus 100A and the condition on discarding a refresh token is not satisfied, even if the service has not been used using the information processing apparatus 100B for a period longer than the discard period, it may be determined that the condition on discarding the refresh token for the information processing apparatus 100B is also not satisfied. Thus, the refresh token managed in the information processing apparatus 100B is not discarded.

Exemplary embodiments of the present disclosure have been described above. However, the technical scope of the present disclosure is not limited to the exemplary embodiments described above. For example, although the discard period is used as the condition on discarding in an exemplary embodiment, a refresh token may be discarded in the case where authentication information about a user has been deleted. A factor for deletion of authentication information about a user may be, for example, transfer or retirement of the user. More specifically, in the case where a user retires, information about the user is typically deleted. In such a case, for determination of the condition on discarding, an operation for detecting authentication information, for example, a user ID, of a non-existent user and discarding a refresh token may be performed. Furthermore, in the example described above, the determination of the condition on discarding is performed every predetermined period of time and a refresh token is discarded. However, in the case where the discard period is set as the condition on discarding, a refresh token may be automatically discarded when the elapsed time since the last used date and time for the service has reached the discard period. Various changes and replacements of configurations within the scope of the technical spirit of the present disclosure are included in the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   receive a request for issuance of an access token to be used when a service is used;
   provide an instruction for issuance of the access token and a refresh token to be used to, when a validity period of the access token has expired, refresh the access token;
   acquire the access token and the refresh token issued in response to the instruction;
   refresh the access token, using the refresh token, based on a predetermined refresh condition; and
   discard the refresh token, based on a predetermined condition on discarding.
      (((2)))

The information processing system according to (((1))), wherein the predetermined condition on discarding includes lapse of a certain period of time without the service being used by a user of the service.

(((3)))

The information processing system according to (((2))), wherein the certain period of time is set according to a type of the service to be used.

(((4)))

The information processing system according to (((2))) or (((3))), wherein the certain period of time is an elapsed time since a last date and time at which the service is used by the user of the service.

(((5)))

The information processing system according to any one of (((1))) to (((4))), wherein the one or more processors are configured to determine, every predetermined period of time, the condition on discarding, based on a use status of the service by the user of the service.

(((6)))

The information processing system according to any one of (((1))) to (((5))), wherein the one or more processors are configured to, in a case where the user of the service uses at least one of a first service and a second service that is associated with the first service, determine that the condition on discarding is not satisfied.

(((7)))

The information processing system according to any one of (((1))) to (((6))), wherein the one or more processors are configured to, in a case where the user of the service uses at least one of a plurality of services that are able to be used using a same access token, determine that the condition on discarding is not satisfied.

(((8)))

The information processing system according to any one of (((1))) to (((7))), wherein the one or more processors are configured to, even in a case where it is determined that the condition on discarding is satisfied for a first information processing apparatus among a plurality of information processing apparatuses that are in a specific relationship, when a service is used on a second information processing apparatus among the plurality of information processing apparatuses that are in the specific relationship, determine that the condition on discarding is not satisfied.

(((9)))

A program for causing a computer to execute:
a function for receiving a request for issuance of an access token to be used when a service is used;
a function for providing an instruction for issuance of the access token and a refresh token to be used to, when a validity period of the access token has expired, refresh the access token;
a function for acquiring the access token and the refresh token issued in response to the instruction;
a function for refreshing the access token, using the refresh token, based on a predetermined refresh condition; and
a function for discarding the refresh token, based on a predetermined condition on discarding.

What is claimed is:

1. An information processing system comprising:
one or more processors configured to:
receive a request for issuance of an access token to be used when a service is used;
provide an instruction for issuance of the access token and a refresh token to be used to, when a validity period of the access token has expired, refresh the access token;
acquire the access token and the refresh token issued in response to the instruction;
refresh the access token, using the refresh token, based on a predetermined refresh condition; and
discard the refresh token, based on a predetermined condition on discarding.

2. The information processing system according to claim 1, wherein the predetermined condition on discarding includes lapse of a certain period of time without the service being used by a user of the service.

3. The information processing system according to claim 2, wherein the certain period of time is set according to a type of the service to be used.

4. The information processing system according to claim 2, wherein the certain period of time is an elapsed time since a last date and time at which the service is used by the user of the service.

5. The information processing system according to claim 1, wherein the one or more processors are configured to determine, every predetermined period of time, the condition on discarding, based on a use status of the service by the user of the service.

6. The information processing system according to claim 5, wherein the one or more processors are configured to, in a case where the user of the service uses at least one of a first service and a second service that is associated with the first service, determine that the condition on discarding is not satisfied.

7. The information processing system according to claim 5, wherein the one or more processors are configured to, in a case where the user of the service uses at least one of a plurality of services that are able to be used using a same access token, determine that the condition on discarding is not satisfied.

8. The information processing system according to claim 5, wherein the one or more processors are configured to, even in a case where it is determined that the condition on discarding is satisfied for a first information processing apparatus among a plurality of information processing apparatuses that are in a specific relationship, when a service is used on a second information processing apparatus among the plurality of information processing apparatuses that are in the specific relationship, determine that the condition on discarding is not satisfied.

9. An information processing method comprising:
receiving a request for issuance of an access token to be used when a service is used;
providing an instruction for issuance of the access token and a refresh token to be used to, when a validity period of the access token has expired, refresh the access token;
acquiring the access token and the refresh token issued in response to the instruction;
refreshing the access token, using the refresh token, based on a predetermined refresh condition; and
discarding the refresh token, based on a predetermined condition on discarding.

10. A non-transitory computer readable medium storing a program causing a computer to execute a process comprising:
receiving a request for issuance of an access token to be used when a service is used;
providing an instruction for issuance of the access token and a refresh token to be used to, when a validity period of the access token has expired, refresh the access token;
acquiring the access token and the refresh token issued in response to the instruction;
refreshing the access token, using the refresh token, based on a predetermined refresh condition; and
discarding the refresh token, based on a predetermined condition on discarding.
